(19) United States
(12) Patent Application Publication
(10) Pub. No.: US 2021/0191154 A1
(43) Pub. Date: Jun. 24, 2021

(54) HYBRID DIFFRACTIVE AND REFRACTIVE CONTACT LENS FOR TREATMENT OF MYOPIA

(71) Applicant: Alcon Inc., Fribourg (CH)

(72) Inventors: David Borja, Suwanee, GA (US); Joseph Michael Lindacher, Suwanee, GA (US); Ying Pi, Suwanee, GA (US)

(21) Appl. No.: 17/125,040

(22) Filed: Dec. 17, 2020

Related U.S. Application Data
(60) Provisional application No. 62/949,793, filed on Dec. 18, 2019.

(51) Int. Cl. G02C 7/04

(52) U.S. Cl. CPC G02C 7/047; G02C 2202/24; G02C 2202/20

(57) ABSTRACT

A hybrid diffractive and refractive contact lens, and methods of treatment of optical conditions using such a lens. A first lens portion is formed from a first lens material having a first index of refraction and includes at least one diffractive optical element. A second lens portion is formed from a second lens material having a second index of refraction different from the first index of refraction. The diffractive optical element may be embedded within the second lens portion to provide comfort, tear film stability, and optical performance.

### TECHNICAL FIELD

The present invention relates generally to the field of vision correction, and more particularly to a soft contact lens with an embedded diffractive optical element. Embedding of the diffractive optical element ensures the diffractive properties of the lens are not impacted by transient factors such as the tear film.

### BACKGROUND

Presbyopia results from a gradual loss of accommodation of the visual system of the human eye. This is due to an increase in the modulus of elasticity and growth of the crystalline lens of the eye that is located just behind the iris and the pupil. Tiny muscles in the eye called ciliary muscles pull or release the crystalline lens, thereby causing the curvature of the crystalline lens to adjust. This adjustment of the curvature of the crystalline lens results in an adjustment of the eye's focal power to bring near objects into focus. As individuals age, the crystalline lens of the eye becomes less flexible and elastic, and, to a lesser extent, the ciliary muscle strength decreases. These changes result in the reduction of accommodative amplitude (i.e., loss of accommodation) which causes objects that are close to the eye to appear blurry. Symptoms of presbyopia result in the inability to focus on objects close at hand. As the modulus of the lens increases, it is unable to form images of intermediate and near distance objects on the retina. People that are symptomatic typically have difficulty reading small print, such as that on computer display monitors, restaurant menus and newspaper advertisements, and may need to hold reading materials at arm's length. There are a variety of non-surgical corrective systems that are currently used to treat presbyopia, including bifocal spectacles, progressive (no-line bifocal) spectacles, reading spectacles, bifocal or multifocal contact lenses, and monovision contact lenses. Surgical corrective systems include, for example, multifocal intraocular lenses (IOLs) and accommodation IOLs inserted into the eye and vision systems altered through corneal ablation techniques.

Myopia (short-sightedness) is another disorder of the eye in which distant objects and blurred due to the focus position in from of the retina. Myopic eyes have the unaccommodated best focus at a near point (e.g., 50 cm for a 2.00 D myope). Objects closer than 50 cm, but not further away, are focused on the retina via accommodation of the crystalline lens. The condition is corrected by the use of lenses with negative central refractive power.

Hyperopia (long-sightedness) is a disorder where distant objects may be focused on the retina only when the crystalline lens is an accommodated state. The condition being corrected by the use of positive power lenses.

The present invention is primarily directed to continuing improvements in the field of corrective measures for vision.

### SUMMARY

In example embodiments, the present invention provides a hybrid diffractive/refractive multifocal contact lens. Some particular embodiments are comprised of two soft contact lens forming materials (e.g., silicone hydrogel, hydrogel, silicone elastomer, gel or encapsulated liquid) with a consistent and well-defined refractive index difference (ΔRI) between the two materials. By embedding a diffractive optical element within the lens substrate, ideal or improved optical performance can be achieved. The smooth, wettable optical surface delivers optimal or improved tear film stability for vision and lens comfort.

The contact lens according to example embodiments utilizes the refractive index difference (ΔRI) between the bulk substrate and embedded diffractive element to achieve multifocality for the treatment and correction of presbyopia, myopia, or other conditions affecting the vision of a treated human or animal subject. The separation of the surface properties of the contact lens and the diffractive optical element provides a consistent predictable high efficiency diffractive optical performance while maintaining the surface characteristics required for a contact lens. Furthermore, separation of the surface refractive optical properties and the embedded diffractive optical properties can allow for correction and or manipulation of chromatic aberration, spherical aberration and or higher order aberrations for a treatment of myopia progression.

In example embodiments, the bulk substrate material properties alone or in combination with a coating layer, provide a wettable smooth continuous optical surface in contact with the ocular surfaces, as well as the oxygen (Dk) and ion permeability required for proper comfort and fit of the contact lens system. Additionally, a coating layer can optionally be applied on the outermost layer of the substrate to further improve tear film stability with a lubricious and wettable surface.

Example applications of the invention include a system for vision correction including a lens and a lens series, for example a contact lens configured for a particular range or type of vision correction, or a series of related contact lenses of similar construction and/or optical characteristics configured for ranges or types of vision correction. Other example aspects of the invention include methods of vision correction utilizing such lenses and/or series of lenses. Other aspects of the invention also include the provision and use of such contact lenses and/or series of contact lenses as a surrogate device for screening potential multifocal intraocular lens patients or other potential vision corrective surgeries, for example by cataract and refractive surgeons.

In one aspect, the present invention relates to a hybrid diffractive and refractive contact lens. The lens preferably includes a first lens portion comprising a first lens material having a first index of refraction, the first lens portion having at least one diffractive optical element. The lens preferably also includes a second lens portion comprising a second lens material having a second index of refraction different from the first index of refraction.

In another aspect, the invention relates to a hybrid diffractive and refractive contact lens for treatment of presbyopia. The lens preferably includes a first lens portion comprising a first lens material having a first index of refraction, the first lens portion having at least one diffractive optical element. The lens preferably also includes a second lens portion comprising a second lens material having a second index of refraction different from the first index of refraction. The lens preferably provides a refractive optical power of between −15D to +8D (diopter), and an optical Add power of the at least one diffractive optical element is between +1D to +8D.

In another aspect, the invention relates to a method of treatment of presbyopia. The method preferably includes providing a hybrid diffractive and refractive contact lens to a user. The lens preferably includes a first lens portion comprising a first lens material having a first index of refraction. The first lens portion preferably includes at least one diffractive optical element. The lens preferably also includes a second lens portion comprising a second lens material having a second index of refraction different from the first index of refraction. The lens preferably provides an optical correction prescribed to treat a presbyopic optical condition of the user. The optical correction preferably includes a refractive optical power of between −15D to +8D and an optical add power of between +1D to +8D.

In another aspect, the invention relates to a vaulted scleral diffractive contact lens. The lens preferably includes a lens body comprising a rigid gas permeable lens material having an index of refraction of at least about 1.5. The lens body preferably defines a base curve including at least one diffractive optical element. The base curve is preferably configured to define a vaulted space between the at least one diffractive element and a wearer's cornea when in use, whereby a tear film encapsulated within the vaulted space forms a lacrimal lens when in use.

In still another aspect, the invention relates to a hybrid diffractive and refractive contact lens for treatment of myopia. The lens preferably includes a first lens portion comprising a first lens material having a first index of refraction. The first lens portion preferably includes at least one diffractive optical element. The lens preferably also includes a second lens portion comprising a second lens material having a second index of refraction different from the first index of refraction. The lens preferably provides a refractive optical power of between −10D to 0D in a central optical zone, and a diffractive optical add power of between +1D to +8D in a peripheral optical zone surrounding the central optical zone.

In another aspect, the invention relates to a multifocal diffractive-refractive contact lens for controlling myopia progression. The lens preferably includes a first lens portion comprising a first lens material having a first index of refraction. The first lens portion preferably includes at least one diffractive optical element. The lens preferably also includes a second lens portion comprising a second lens material having a second index of refraction different from the first index of refraction. The lens preferably also includes a central optical zone providing a refractive optical power, and a peripheral optical zone surrounding the central optical zone. The at least one diffractive optical element preferably provides a diffractive add power in the peripheral optical zone of between +1D to +8D.

In another aspect, the invention relates to a method of treatment of myopia. The method preferably includes providing a hybrid diffractive and refractive contact lens to a user. The contact lens preferably includes a first lens portion comprising a first lens material having a first index of refraction. The first lens portion preferably includes at least one diffractive optical element. The lens preferably also includes a second lens portion comprising a second lens material having a second index of refraction different from the first index of refraction. The contact lens preferably provides an optical correction prescribed to treat a myopic optical condition of the user. The optical correction preferably includes a refractive optical power of between −10D to 0D in a central optical zone, and a diffractive optical add power of between +1D to +8D in a peripheral optical zone surrounding the central optical zone.

These and other aspects, features and advantages of the invention will be understood with reference to the drawing figures and detailed description herein and will be realized by means of the various elements and combinations particularly pointed out in the appended claims. It is to be understood that both the foregoing general description and the following brief description of the drawings and detailed description of example embodiments are explanatory of example embodiments of the invention, and are not restrictive of the invention, as claimed.

### BRIEF DESCRIPTION OF THE DRAWINGS

FIG. 1 is a perspective view of a hybrid diffractive-refractive contact lens according to an example embodiment of the present invention.

FIG. 2A is a perspective exploded or assembly view of a hybrid diffractive-refractive contact lens according to another example embodiment of the invention.

FIG. 2B is a perspective exploded or assembly view of a hybrid diffractive-refractive contact lens according to another example embodiment of the invention.

FIG. 2C is a cross-sectional view of an edge portion of the hybrid diffractive-refractive contact lens of FIG. 2B.

FIG. 3A is a partial cross-sectional schematic view of a multi-layer contact lens having layers of differing refractive index.

FIG. 3B is a partial cross-sectional schematic view of a hybrid diffractive-refractive contact lens having embedded diffractive optical elements, according to an example embodiment of the invention.

FIG. 3C is a partial cross-sectional schematic view of a hybrid diffractive-refractive contact lens having embedded diffractive optical elements, according to another example embodiment of the invention.

FIG. 4A is a cross-sectional view of a bilayer contact lens with embedded diffractive optical elements according to an example embodiment of the invention.

FIG. 4B is a partial cross-sectional detail of the bilayer contact lens of FIG. 4A.

FIG. 4C is a cross-sectional view of a bilayer contact lens with embedded diffractive optical elements according to another example embodiment of the invention.

FIG. 4D is a partial cross-sectional detail of the bilayer contact lens of FIG. 4C.

FIGS. 5A-5E show further details of the layer construction of the lens during fabrication, and optional rounding of the diffractive structure embedded in a bilayer contact lens, according to an example embodiment of the invention.

FIGS. 6A-6E are cross-sectional and detail views of example embodiments of multi-layer diffractive-refractive contact lenses according to the invention.

FIGS. 7A and 7B show a vaulted scleral diffractive contact lens according to another example embodiment of the invention.

FIGS. 8A-8I are energy balance charts showing light (image) relative intensity of different zones or focal distance ranges generated by hybrid diffractive-refractive contact lenses according to example embodiments of the invention.

### DETAILED DESCRIPTION OF EXAMPLE EMBODIMENTS

The present invention may be understood more readily by reference to the following detailed description of example embodiments taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

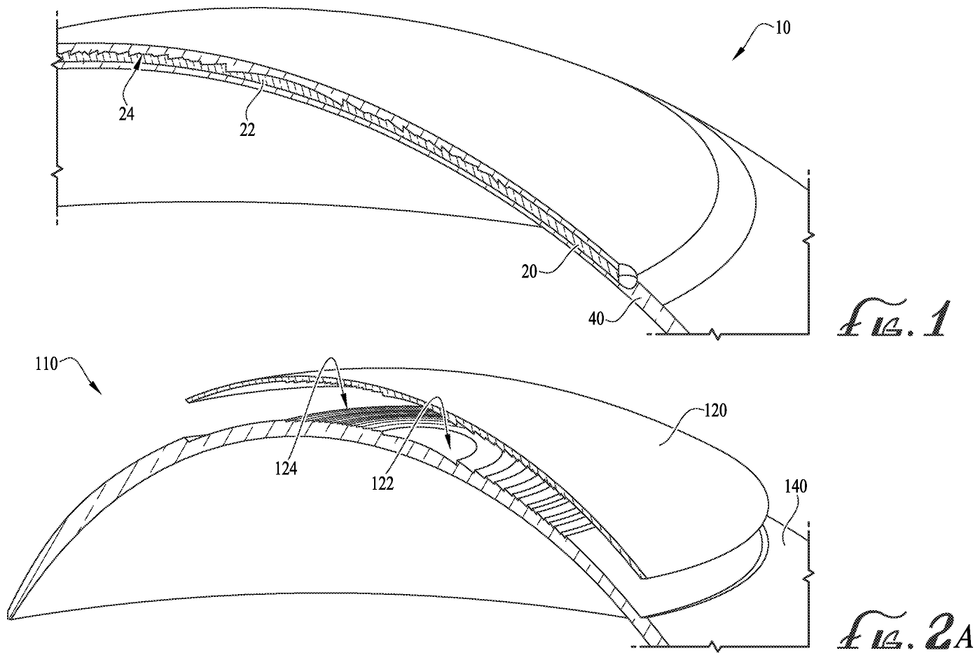

With reference now to the drawing figures, wherein like reference numbers represent corresponding parts throughout the several views, FIG. 1 shows a hybrid diffractive-refractive soft contact lens 10 according to an example embodiment of the invention. The lens 10 comprises an over-molded inlay or laminate structure formed of at least two materials, with an inner diffractive optical element 20 embedded within an outer lens substrate 40. Embedding of the diffractive optical element 20 separates the surface, refractive and biomechanical properties of the lens substrate 40 from the diffractive optical properties. In example embodiments, the diffractive optical element 20 and lens substrate 40 are co-molded, over-molded, or otherwise fabricated. The diffractive optical element 20 comprises a central optical zone 22, and a peripheral optical zone 24 surrounding the central optical zone. In the depicted embodiment, the central optical zone 22 is generally circular in plan profile (i.e., viewed from above or below), and the peripheral optical zone 24 has a generally annular profile. The peripheral optical zone 24 defines an irregular or discontinuous cross-sectional profile, for example comprising a series of peaks and valleys or saw-tooth profile, forming an annular pattern of concentric circles or a spiral pattern of diffractive elements in plan profile, to produce diffractive optical effect(s), and optionally also to assist in attachment of the diffractive optical element 20 to the lens substrate 40. In example embodiments, the diffractive optical element is approximately 3 to 6 mm in diameter. The height and spacing of the diffractive steps/rings depend on the refractive index of the two materials and the optical design including the add power(s) and energy distribution between the multiple foci. Typically, the height of the diffractive steps would be approximately 0.5 microns to 20 microns, for example about 3 microns to about 5 microns, determined by the difference in indices of refraction. The diffractive step heights could be constant for each ring or could vary with each ring to create multiple foci with different add powers or to modulate the energy balance between the different foci. The ring spacing will create zones of equal area. Typically, the optical design will include 1 to 25 rings/zones over the central 3 to 6 mm optical zone diameter, for example about 6-18 rings or zones. The ring dimensions will be dependent on the optical design, in particular add power(s). Higher add powers would require more rings in the same given area [Equation 036].

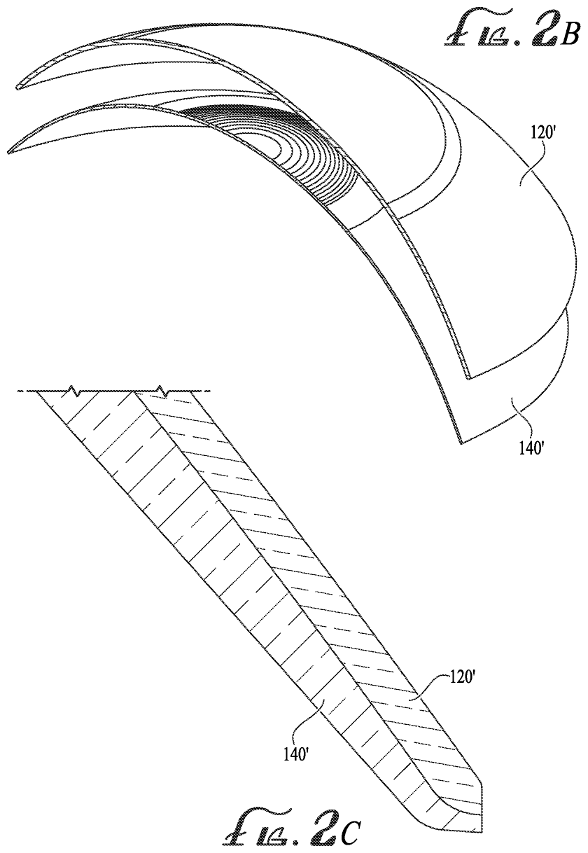

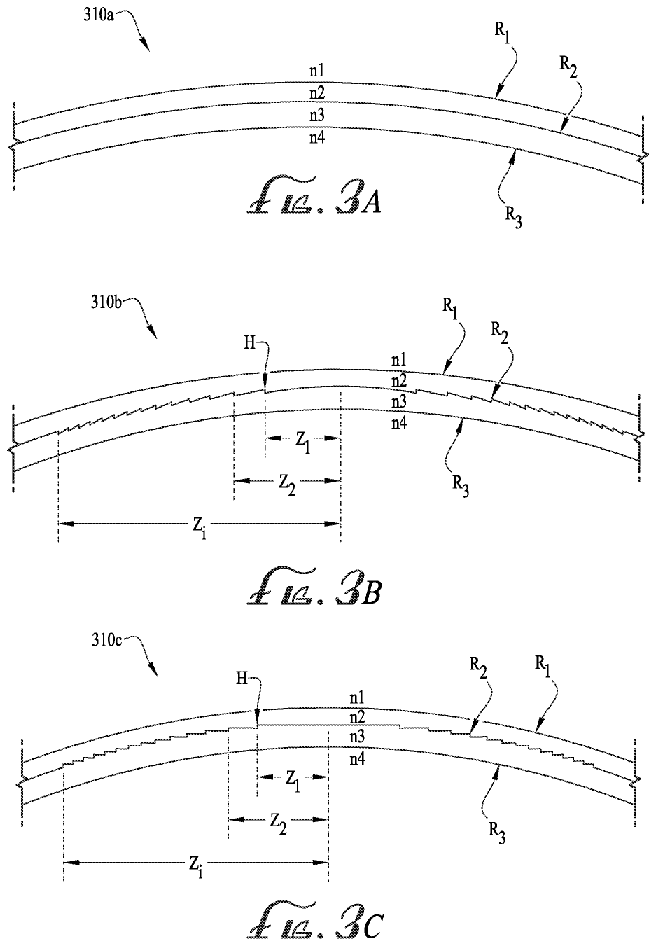

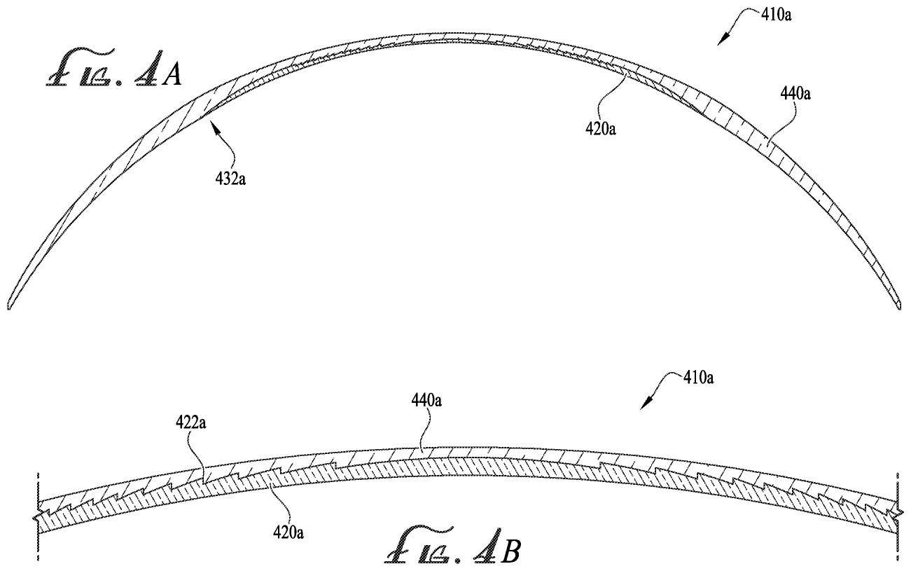

FIG. 2A shows another example embodiment of a hybrid diffractive-refractive soft contact lens 110 according to the invention. The lens 110 comprises a diffractive optical element 120 partially embedded within a lens substrate 140. The diffractive optical element 120 comprises a central optical zone 122, and a peripheral optical zone 124 surrounding the central optical zone. The central optical zone 122 is generally circular in plan profile (i.e., viewed from above or below), and the peripheral optical zone 124 has a generally annular profile. The peripheral optical zone 124 defines an irregular or discontinuous cross-sectional profile, for example a saw-tooth cross-sectional configuration comprising a series of peaks and valleys forming an annular pattern of concentric circles or a spiral pattern of diffractive elements. In this embodiment, the diffractive optical element 120 may be co-molded or over-molded with the lens substrate 140, or alternatively a recessed portion defining the diffractive elements may be formed within the lens substrate and the diffractive optical element applied as a coating over the recessed portion. The diffractive element is molded either in to the backside of 120 or onto the front side of 140. In the case of the diffractive element is molded onto the front side of 140, 120 could be 1) a coating layer, which is applied on top of 140 or 2) a second molding step which partially utilizes 140 as a mold for element 120. In the case the diffractive element is molded into the backside of 120, the front side mold of 120 could be reused as the front side mold of 140 without removing element 120 from the front side mold. In this case, element 120 would extend from an intermediate diameter as shown in FIG. 2A, or alternatively could extend to the edge of the lens. For example, FIGS. 2B and 2C show an alternate embodiment of a lens wherein a diffractive optical element 120′ and a lens substrate element or coating layer 140′ extend to or substantially to the lens edge.

In the depicted embodiments, the diffractive optical element 120, 120′ is over-molded or coated on the front curve of the lens 110, 110′, but in alternative embodiments it may be applied to the base curve or embedded within the lens substrate 140, 140′. In embodiments wherein the diffractive optical element 120 is not embedded within the lens substrate 140, the lens 110 preferably comprises a smooth and continuous surface at the transition between the diffractive optical element and the lens substrate.

In the various embodiments disclosed herein, the contact lens 10, 110 comprises at least two lens portions, with a first portion comprising a first lens material having a first refractive index (n₁), and a second portion comprising a second lens material having a second refractive index (n₂) that is significantly different than the first refractive index, i.e., n₁≠n₂. In further embodiments, three or more lens portions of differing materials and refractive indices may be provided. The lens materials all preferably have a high degree of transparency for optical light and image transmission. For example, the lens substrate 40, 140 or other first portion or first layer of the lens may be formed of a first material (M₁) having a first refractive index, and the diffractive element 20, 120 or other second portion or second layer of the lens may be formed of a second material (M₂) having a second refractive index differing from the first refractive index. In this manner a consistent and well-defined refractive index difference (ΔRI) is defined between the first and second materials, and correspondingly between the first and second lens portions, thereby providing the lens with refractive optical characteristics or correction as light crosses the boundary between the two materials. Additionally, the lens geometry within the optical zone is configured to provide diffractive optical characteristics or correction as light encounters the discontinuities of the diffractive elements of the lens. Thus, a hybrid contact lens having both refractive and diffractive characteristics or correction features is provided. The central total thickness of this lens will be from 50 to 350 microns thick which is in the range of most commercially available soft silicone hydrogel contact lenses. The minimum thickness for the layer containing the diffractive optic will be at least 2 (two) times the height of the maximum diffractive step heights to avoid impacting the diffracted light.

In example embodiments, a difference in refractive index (ΔRI) range of 0.03-0.5 is provided between the first and second lens materials. More preferably, a difference in refractive index (ΔRI) of at least about 0.1 is provided between the first and second lens materials. For example, the first lens portion may comprise a hydrogel or a silicon hydrogel first lens material (M₁) having a first refractive index (n₁) of about 1.40-1.42, and the second lens portion may comprise a silicon elastomer second lens material (M₂) having a second refractive index (n₂) of about 1.50-1.55, resulting in a ΔRI of for example at least about 0.08-0.15, for example about 0.10. Defined in relative terms, in example embodiments, the difference in refractive index (ΔRI=n₂−n₁) between the first and second lens materials may be at least about 3%-4%, for example about 5%, and more preferably at least about 6%-7% of the average of the first and second refractive indices (n₁+n₂/2). Example first lens materials (M₁) include, without limitation: verofilcon A (RI=1.417), lotrafilcon B (RI=1.42), delefilcon A (RI=1.4225), verofilcon A (RI=1.407), serafilcon A (RI=1.4013), lehfilcon A (RI=1.4013), nelfilcon A (RI=1.383). Example second lens materials (M₂) include, without limitation: silicone elastomer (RI=1.40 to 1.60), Acrylate PMMA (RI=1.491), Fluorosilicone elastomer (RI 1.46 to 1.60). Optionally, the first and second lens materials gel at different temperatures during formation of the lens.

In preferred embodiments, the first and second lens materials are selected to have high degrees of optical transparency for suitable optical performance, and to have compatible material properties (e.g., similar thermal expansion coefficients, hydration characteristics or hydrophilicities, moduli of elasticity, and material bonding characteristics) to resist delamination or detachment of the first and second lens portions during the intended useful life of the lens products. Additionally, the materials of the first and second lens portions are preferably selected to provide a short interpenetrating network or depth of bond, thereby providing a sharp index of refraction transition between the first and second materials rather than a more gradual blending of materials at the transition of the first and second lens portions when co-molding or otherwise fabricating the lens products. In example embodiments, both the first and second lens materials M₁, M₂ comprise soft contact lens materials having a relatively low elastic modulus. In alternate embodiments, a higher modulus or harder material such as a rigid gas permeable lens material may be embedded in a lower modulus or softer material, or vice versa. For example, a low RI material such as nelfilcon A (RI=1.383), lotrafilcon B (RI=1.42) or delefilcon A (RI=1.4225) and a higher RI material such as Fluorosilicone acrylates or silicone elastomers (RI 1.51 to 1.54),

In carrying out the optical design of a multilayer refractive-diffractive contact lens according to example forms of the invention, the paraxial optical power of a multilayer refractive contact lens made up of n layers is given by the equation:

$$P = {P}_{1} + {P}_{2} - \frac{( {N}_{2} - {N}_{1} )}{{N}_{2}} * ( \frac{{d}_{1}}{{R}_{1} * {R}_{2}} ) + {P}_{3} - \frac{( {N}_{1} - {N}_{2} )}{{N}_{3}} * ( \frac{{d}_{2}}{{R}_{3} * {R}_{2}} ) + ** * Pn - \frac{( {N}_{n} - {N}_{n - 1} )}{{N}_{n}} * ( \frac{{d}_{n}}{{R}_{n} * {R}_{n} - 1} )$$

Where dₙ is the thickness of each layer and Pₙ is the paraxial optical power of a layer with radius of curvature Rₙ and thickness and refractive index Nₙ is given by:

$${P}_{n} = \frac{{N}_{n} - {N}_{n - 1}}{n}$$

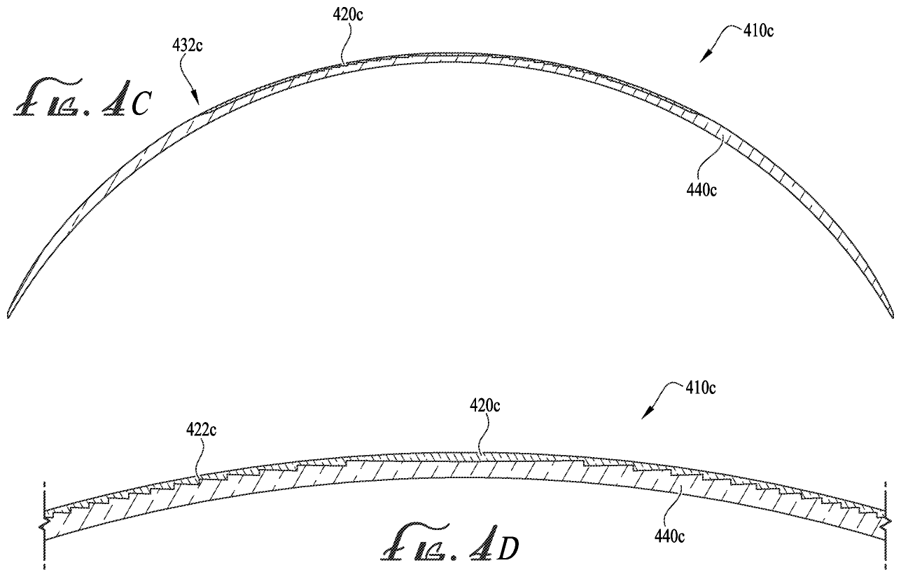

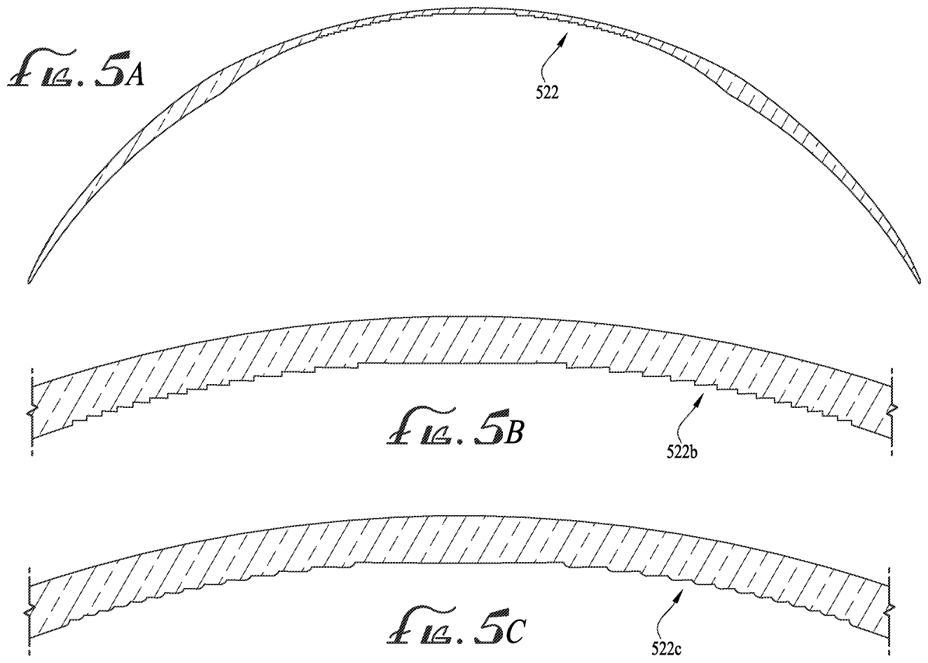

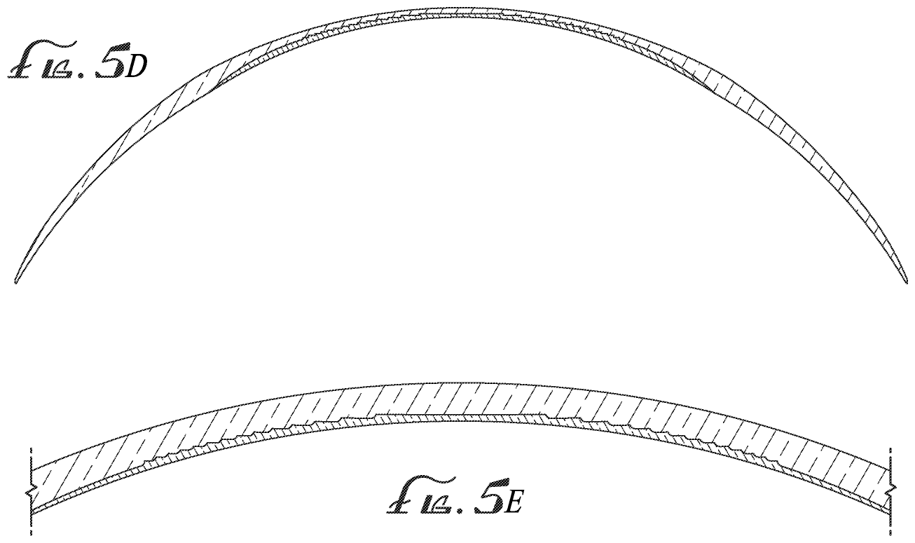

In the case of a three-layered lens 310a as in FIG. 3A. Schematic of a three-layer refractive contact lens, with layer radii R and indices of refraction n:

$${P}_{1} = \frac{{N}_{2} - {N}_{1}}{{R}_{1}} , {P}_{2} = \frac{{N}_{3} - {N}_{2}}{{R}_{2}} , and {P}_{3} = \frac{{N}_{4} - {N}_{3}}{{R}_{3}}$$

A kinoform is a diffractive optical element that can be described as a combination of a refractive sag profile and a diffractive sag profile. In the case of a three-layered contact lens with an embedded kinoform diffractive optical element the surface sag profile is given by:

$${Z}_{2} = {Z}_{ref} + {Z}_{diff}$$

$${Z}_{ref} = \frac{c {ϰ}^{2}}{1 + \sqrt{1 - ( 1 + k ) {c}^{2} {ϰ}^{2}}} + \sum {a}_{n} {ϰ}^{n}$$

Where c is the inverse of the instantaneous radius of curvature (c=1/R₂) at the apex of the surface, k is the conic constant x is the radial position on the surface and an are the asphericity coefficients.

The diffractive surface profile is given by:

$${Z}_{diff} = \frac{m λ ϕ ( ϰ )}{{N}_{3} - {N}_{2}} {ϰ}^{2}$$

Where m is the diffraction order, λ is the design wavelength and φ(x) is a phase function in the radial x direction. The robustness of this approach is a that a variety of different phase functions can be used in this system including a modulo 2pi kinoform design which would function as a Fresnel lens, an apodized bifocal lens design similar to ReSTOR™ or a quadrafocal design similar to PanOptix™ which would result in a trifocal lens. Also, this approach will allow for different refractive index transitions between the surfaces across the diffractive optical element. For example, FIG. 3B shows the three-layer diffractive lens 310b with a modulo 2pi kinoform where n₃>n₂. While FIG. 3C shows a similar design of a lens 310c where n₃<n₂. Additionally, the diffractive structure could be designed to correct for chromatic aberrations of the refractive structures of the contact lens or of the eye in general.

The radial position x of the diffractive transitions is a function of the diffractive optical power to be added to the system or Add power and the wavelength, with zones Z indicated for an example bifocal embodiment:

$$Zone ( i ) = \sqrt{\frac{2 l λ}{Add}}$$

And the height H of the diffractive transition is given by:

$$Height ( i ) = \vert \frac{m λ}{{N}_{n} - {N}_{n - 1}} \vert$$

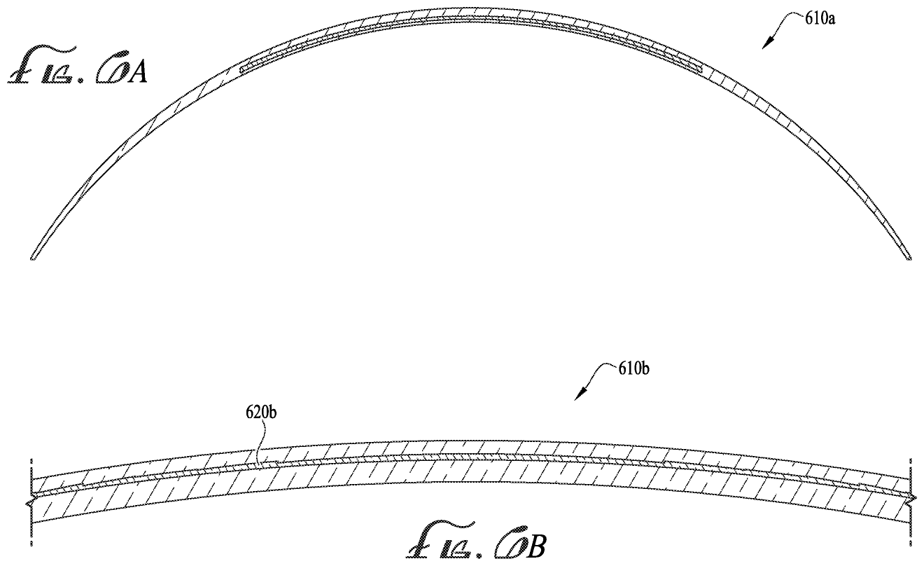

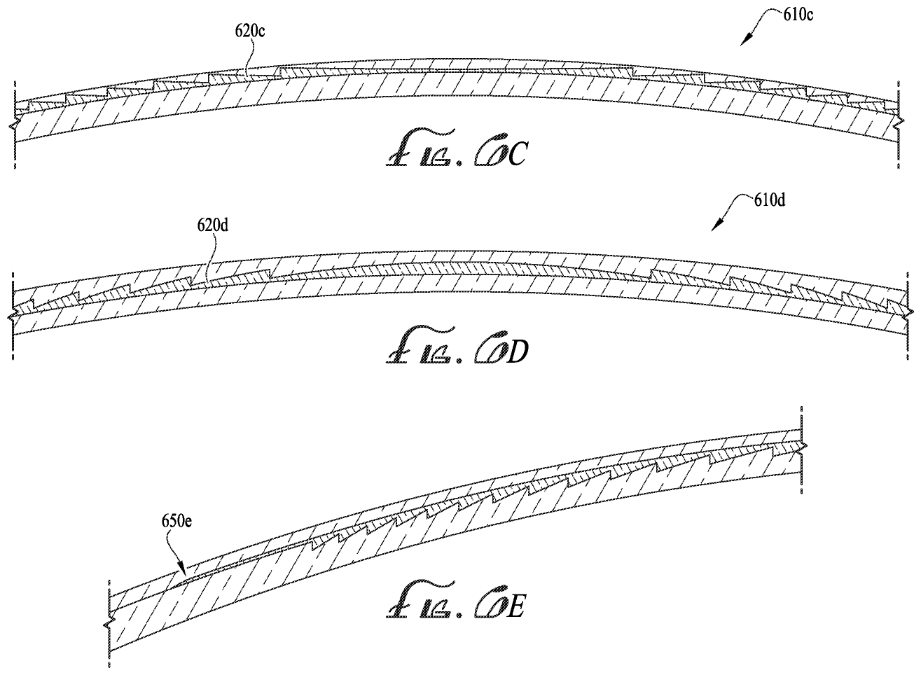

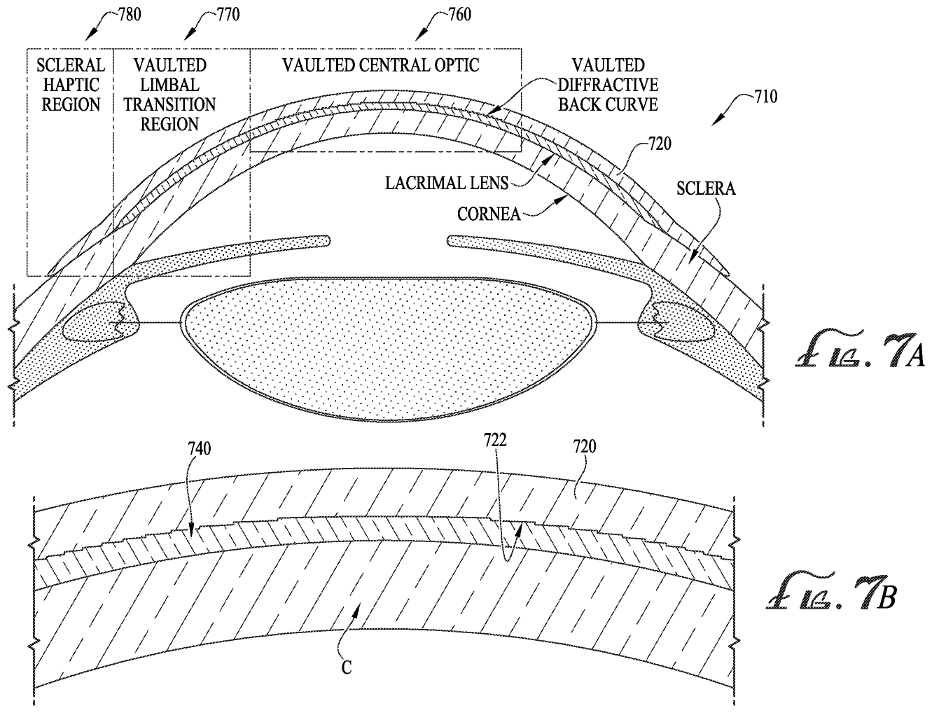

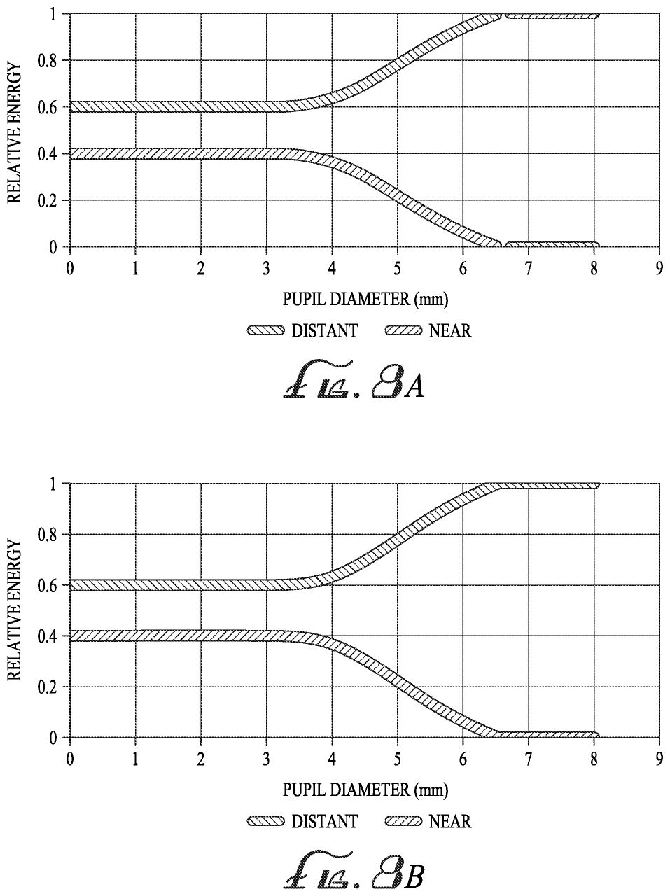

In the mechanical design and fabrication of a multilayer refractive-diffractive contact lens, in the case of a bilayer embedded diffractive contact lens 410a, where the first layer has a lower refractive index than the second layer (n₃>n₂), a diffractive surface profile similar to FIGS. 4A and 4B would be generated at the interface. Materials such as nelfilcon A (n˜1.38) and lotrafilcon B (n₃˜1.42) can be used. In the inverse case n₃<n₂, a surface profile of a lens 410c similar to that shown in FIGS. 4C and 4D would be produced. The saw tooth structure of the diffractive elements 422a, 422c may help mechanically bond the two materials during the fabrication process during use. Furthermore, a mechanical bonding region 432a, 432c can be designed into the anterior or posterior bulk material as shown in FIGS. 4A and 4C.

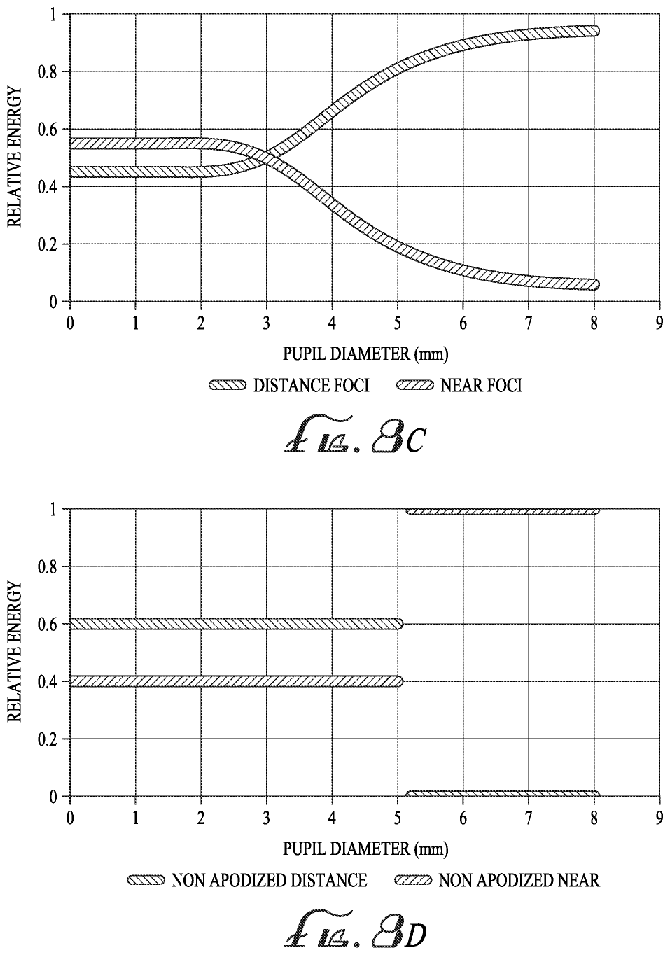

In the design embodiment illustrated FIGS. 4C and 4D, the diffractive structure 420c can be recessed into the bulk of the lens substrate 440c of the device and then coated by the front most layer of the device. The design will result in a smooth external surface in contact with the eye lid. In the design embodiment illustrated in FIGS. 4A and 4B, the diffractive structure 420a can be recessed into the base curve of the bulk material of the lens substrate 440a which is then coated with the second layer. Provision of a relatively thick coating (i.e., at least about two times the height of the diffractive elements) over the diffractive structure may aid in comfort and prevent corneal molding and excess pressure from the diffractive structures on the cornea and tear film. The sequence of lens formation and application of a coating layer within a recessed portion of the base curve over the diffractive elements with the second lens material is shown in FIG. 5A (uncoated) and FIGS. 5D-5E (coated). The design of the diffractive structure 522 can also optionally incorporate a rounding feature which will further reduce any contact pressure which may occur with the cornea or eye lid. FIG. 5B shows a small amount of rounding of the diffractive structure 522b (approximately 25 μm) which may be needed for fabrication, while FIG. 5C shows additional rounding of the diffractive structure 522c (approximately 10× of FIG. 5B).

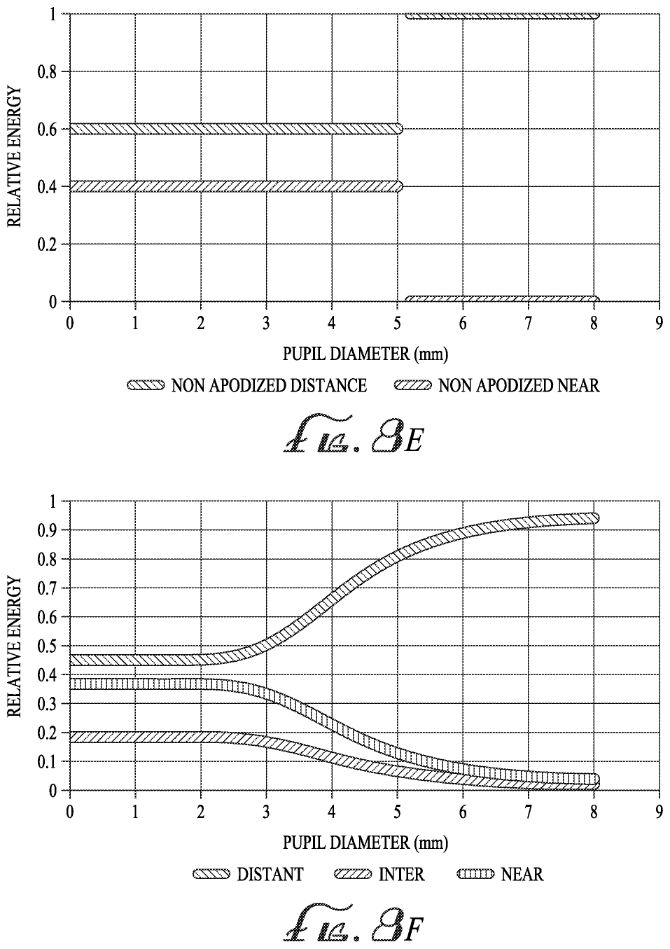

FIG. 6A illustrates a three-layer design of a contact lens 610a having four surfaces where refraction occurs (i.e., at the inner and outer surfaces, and at interfaces between layers), according to another example embodiment of the invention, where the two outermost layers can be the same or different materials. The design illustrated in FIG. 6B, shows an embedded element 620b with one diffractive surface, one refractive surface and a refractive index different from the first and third layers. The element can be fabricated in a separate molding process and then assembled during the molding of the bulk material. The designs illustrated in FIGS. 6C and 6D have lenses 610c, 610d with embedded elements 620c, 620d with different diffractive surfaces. In alternate embodiments, the embedded element may have diffractive surfaces on both its front and back faces, whereby both diffractive surfaces can work together to add multiple focal points, minimize chromatic aberrations and increase diffraction efficiency across a larger wavelength bandwidth than a single diffractive surface. A mechanical bonding feature 650e can be placed in the periphery of the lens, as shown in FIG. 6E to allow for excellent optical performance across the optical zone while preventing delamination of the multiple layers.

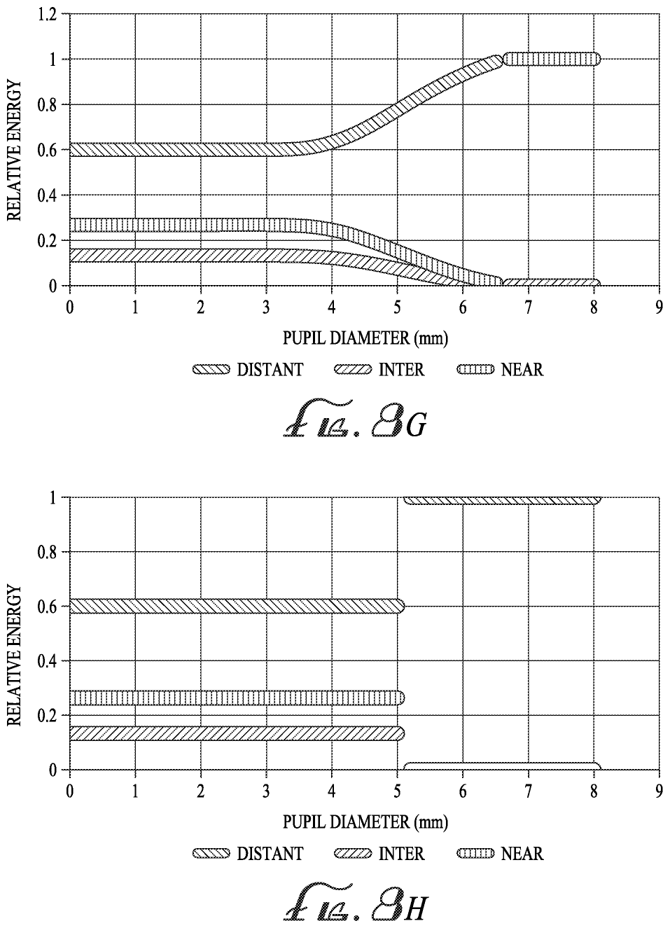

FIGS. 7A and 7B show a presbyopia correcting contact lens system 710, which utilizes a diffractive base curve optic mechanism of action combined with a vaulted scleral contact lens 720. The vaulted or raised configuration of the lens 720 maintains a vaulted space between the base or back curve of the lens and the wearer's cornea C. In example embodiments, the height of the vaulted space between the lens and the cornea, can be from about 100 microns to 200 microns, for example about 150 microns. Typically, the vaulted space is filled with tears or artificial tears. In example embodiments, the lens 720 comprises a rigid gas permeable (RGP) lens material to maintain the lens vault in use. The lens 720 comprises a diffractive base curve or back surface comprising one or more diffractive optical elements 722, such as for example an annular pattern of concentric circles or a spiral pattern of diffractive elements in plan profile and defining a series of peaks and valleys or saw-tooth profile in cross-section, to provide a diffractive optical correction or effect. The vaulted space between the back or base curve of the lens 720 and the cornea C creates a consistent predictable lacrimal lens 740 formed from tear fluid within the vaulted space. The refractive index difference (ΔRI) between the tear fluid (nₜₑₐᵣ≈1.33) and the material of lens 720 (RI˜1.51 to 1.54) and the lens geometry produce a refractive optical correction or effect at the tear film/contact lens interface.

This vaulted embodiment overcomes limitations of comfort, corneal molding, tear film stability (which impacts diffractive performance), alignment and registration that might otherwise result from the diffractive elements 722 on the base curve of the lens 720. The vaulted base curve diffractive structure 722 can also provide consistent optical performance independent of existing pathologic properties of the cornea C (i.e., astigmatism, keratoconus, corneal and ocular surface diseases such as dry eye) and overcome limitations of current multifocal contact lenses which cannot be combined with astigmatism correction or highly abberrated eyes. Compared to surgical presbyopia treatments (such as PresbyLasik, Kamra Corneal Inlay, Multifocal IOL's) this vaulted scleral diffractive contact lens 720 will have a lower risk profile since it can be removed non-surgically if the patient cannot tolerate the diffractive mechanism of action. And the optical performance can be optimized based on patient feedback by changing lenses.

The refractive effects on eye of the vaulted scleral contact lens 720 depends on the power of the contact lens (as measured in air) and the power of the lacrimal lens 740 formed by the tear film between the cornea C and the base curve of the vaulted contact lens (as measured in air), which is created by the vault and the mismatch in radius of curvature of the scleral lens base curve and the anterior curvature of the cornea C. In the case of this embodiment, the diffractive optical elements 722 on the base curve of the scleral contact lens 720 further combines with the total power of the contact to provide multiple “add” powers depending on the diffractive optic design.

The total power of the three components, the lens, the diffractive element and the lacrimal lens is given by the equation:

P_{Total}−P_{Lens}+P_{Lacrimal}+P_{Diffractive}

The diffractive element may include multiple foci. The optical power of the scleral lens in air is given by:

$${P}_{Lens} = \frac{( {N}_{Lens} - {N}_{air} )}{{R}_{Front}} + \frac{( {N}_{air} - {N}_{lens} )}{{N}_{Back}} - \frac{( {N}_{lens} - {N}_{air} )}{{N}_{Lens}} * ( \frac{{Thickness}_{Lens}}{{R}_{Front} * {R}_{Back}} )$$

Where the Thickness_{Lens} is the thickness of the lens, R_{Front} and R_{Back} are the radii of curvature of the front and back surface of the contact lens and N_{Lens} and Nₐᵢᵣ are the indices of refraction of the lens and air.

$${P}_{Lacrimal} = \frac{( {N}_{Air} - {N}_{water} )}{{R}_{Back}} + \frac{( {N}_{water} - {N}_{air} )}{{R}_{Ant \_ Cornea}} - \frac{( {N}_{water} - {N}_{air} )}{{N}_{water}} * ( \frac{{Thickness}_{Tear}}{{R}_{Front} * {R}_{Ant \_ Cornea}} )$$

In this embodiment, the power of the diffractive element can be adjusted based the target requirements of the product. For instance a +3D or +2.5D power can be used to provide a presbyopia treatment. While a zero power diffractive can be used to correct for chromatic aberration.

P_{Diffractive}=Add

In this embodiment the vaulted back curve and lacrimal lens provide a consistent refractive index value for the design of the kinoform diffractive optical element which will be part of the vaulted base curve surface profile.

$${Z}_{base curve} = {Z}_{ref} + {Z}_{diff}$$

$$and$$

$${Z}_{ref} = \frac{c {ϰ}^{2}}{1 + \sqrt{1 - ( 1 + k ) {c}^{2} {ϰ}^{2}}} + \sum {a}_{n} {ϰ}^{n}$$

Where c is the inverse of the instantaneous radius of curvature (c=1/R_{Back}) at the apex of the surface, k is the conic constant x is the radial position on the surface and aₙ are the asphericity coefficients.

The diffractive surface profile is given by:

$${Z}_{diff} = \frac{m λ ϕ ( ϰ )}{{N}_{water} - {N}_{lens}} {ϰ}^{2}$$

Where m is the diffraction order, λ is the design wavelength and φ(x) is a phase function in the radial x direction. The robustness of this approach is that a variety of different phase functions can be used in this system to provide a multiple number of foci to meet the requirements of the design intent of the product. For instance, a modulo 2pi kinoform design which would function as a Fresnel lens would provide a bifocal presbyopia correcting performance on eye. Additionally, the phase function can be set to an apodized bifocal lens design similar to ReSTOR™ or a quadrafocal design similar to PanOptix™ which would result in a trifocal lens. Additionally, the diffractive structure could be designed to correct for chromatic aberrations of the refractive structures of the contact lens or of the eye in general.

The radial position x of the diffractive transitions is a function of the diffractive optical power to be added to the system or Add power and the wavelength:

$$Zone ( i ) = \sqrt{\frac{2 l λ}{Add}}$$

And the height of the diffractive transition is given by:

$$Height ( i ) = \vert \frac{m λ}{{N}_{water} - {N}_{lens}} \vert$$

In example embodiments, the mechanical design of the vaulted scleral diffractive contact lens 720 will have three regions, as indicated in FIG. 7A:

(1) The vaulted central optic region 760.

(2) The vaulted limbal transition region 770.

(3) The scleral haptic or landing region 780.

In example embodiments, the scleral haptic region 780 closely matches the surface curvature of the sclera to maximize contact area, minimize bearing pressure and provide the vault for the limbal region 770 and central optic region 760. Three-dimensional non-contact biometry of the scleral region can be used to provide a starting point of the scleral haptic design and minimize fitting complexity. The limbal transition region 770 is preferably vaulted to maintain the health of the limbus. The limbal region 770 utilizes a reverse radius or spline surface to blend between the scleral haptic region 780 and the central optic region 760. In example embodiments, the vaulted diffractive central optic 760 will preferably utilize a 50-200 micron vault to maintain the consistent lacrimal lens 740 for throughout the day comfort and optical performance.

In example embodiments, the lens 720 is utilized as a multifocal presbyopia correcting contact lens providing high quality vision for distance, intermediate (60 cm) and near (40 cm) vision. In alternate embodiments, the lens 720 is utilized as a predictive surrogate lens for screening visual disturbances and subject selection of diffractive multi-focal intraocular lenses (IOLs, e.g., PanOptix™ or ReSTOR™). Patient selection via predictive contact lens screening may improve clinical outcomes (i.e., reduce complaints and surgical lens explants for visual disturbances) and increase a cataract and refractive surgeon's confidence in multifocal IOL device performance.

In various embodiments, the present invention provides a hybrid diffractive and refractive multifocal contact lens or lens system. The lens or lens system comprises two or more lens portions, layers or components of at least two materials having differing indices of refraction, for example two different soft lens materials (for example, hydrogel and/or silicone hydrogel), a hard and a soft lens material, or a hard or soft lens material and a lacrimal lens portion formed of tear film. At least one of the lens portions comprises one or more diffractive optical elements. Optionally, the outermost surfaces of the multilayer contact lens can be further coated with a hydrophilic coating material such as an in-package coating (IPC) to improve surface wettability. The invention may also take the form of a series of such lenses, the series comprising a plurality of contact lenses as disclosed herein, the lenses in the series having one or more related characteristics, and providing a sequence of varying degrees and/or types of vision correction. The refractive optical power of the contact lens according to example embodiments will be between −15D (diopter) to +8D and will correct for spherical ameptropia. The base curve, sag and diameter of each transition zone will vary to match the combined lacrimal lens power and contact lens optical power to the required spherical corrective power. The optical power (Add power) of the diffractive component of example embodiments of the contact lens will be on the order of +1 to +8D but typically about +2.5D for near vision and about 1.6D for intermediate vision.

The invention further includes methods of treatment or correction of vision in a human or animal subject. For example, a contact lens as disclosed herein may be prescribed and worn on the eye of the subject for correction of presbyopia, providing high quality vision for distance (object at approximately 6 m), intermediate (an object at 80 to 60 cm) and near (an object at 40 cm or closer). The invention also includes methods of use of a contact lens as disclosed herein as a surrogate device to explore patient screening for potential multifocal intraocular lens (IOL) patients. In this case, the device could be sold to cataract and refractive surgeons as screening tool. The contact lens may be used as a predictive surrogate lens for visual disturbances and subject selection of diffractive multi-focal IOLs (e.g., PanOptix™ or ReSTOR™). Patient selection via predictive contact lens screening may improve clinical outcomes (i.e., reduce complaints and surgical lens explants for visual disturbances) and increase the surgeon's confidence in multifocal IOL device performance.

By embedding a diffractive optical element of a contact lens within a lens substrate or coating layer, or by providing a lacrimal (tear film) lens within a vaulted space between a lens and the subject's cornea, a consistent optical performance can be achieved while maintaining a comfortable smooth surface optical surface due to the separation of surface and biomechanical properties from the diffractive optical properties of the embedded element. The diffractive optical element utilizes the refractive index difference (ΔRI) between the substrate and embedded element to achieve multifocality for the treatment and correction of presbyopia. The refractive optical power of the contact lens according to example embodiments will be on the order of −15D to +8D and will correct for spherical ameptropia. The refractive power of the contact lens may also include cylindrical power, for example between −0.5D to −2.75D to correct for astigmatism. The optical power (Add power(s)) of the Diffractive component of the contact lens according to example embodiments will be on the order of +1D to +8.0D but typically about +2.5D for the correction of near vision and about 1.6D for intermediate vision. The separation of the surface properties of the contact lens and the diffractive optical element provides a consistent predictable high efficiency diffractive optical performance while maintaining the surface characteristics required for a contact lens. Furthermore, separation of the surface refractive optical properties and the embedded diffractive optical properties can allow for correction and or manipulation of chromatic aberrations and or spherical aberration and or higher order aberrations for a treatment of myopia progression. The substrate material properties alone or in combination with a coating layer, provide a wettable optical surface in contact with the ocular surfaces as well as the oxygen (Dk) and ion permeability required for proper comfort and fit of the contact lens system. Additionally, a coating layer can be applied on the outermost layer of the substrate to optimize tear film stability.

In example embodiments, the contact lens can deliver corrective power over a relatively large corrective zone for larger pupils (e.g., up to about 4 mm diameter or larger), can provide correction of spherical and/or chromatic aberrations, improved image quality, and/or astigmatism correction, and can provide a higher ADD power (for example +2 to +8 or more) for treatment of presbyopia than provided by purely refractive multifocal lenses. In further embodiments, the contact lens provides independent optical properties (refractive and diffractive), biomechanical properties (modulus, thickness, curvatures and profile etc.,) and surface properties of the substrate and the embedded element, which allows for independently tailoring the multifocal optical properties without impacting the surface or biomechanical properties. In example embodiments, the chromatic aberration produced by the diffractive elements of the contact lens of the present invention may also be utilized to offset or cancel the natural refractive chromatic aberration of the eye, due to the opposite material color dispersion effects of refraction and diffraction (i.e., blue light will focus in front of red light in refraction (positive dispersion), whereas red will focus in front of blue in diffraction (negative dispersion)).

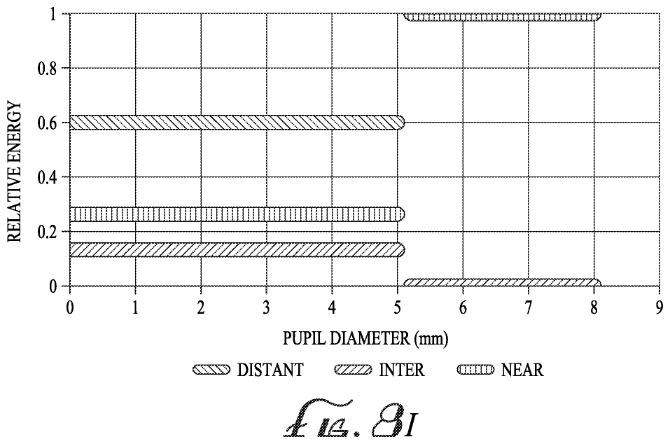

The diffractive technology of the contact lens of the present invention splits light into multiple diffraction orders in a controlled manner. Therefore, sharp acuity can be achieved for multiple vergence distances (i.e., distance, intermediate, near) from a single diffractive zone. The energy distribution among foci, and across the zone (apodization), can be adjusted for vision and efficacy requirements. FIGS. 8A-8I show energy balance charts with light (image) relative energy intensity for different zones or focal distance ranges generated by various diffractive or hybrid diffractive-refractive contact lenses according to example embodiments of the invention. By splitting the light (image) into two or more diffraction orders, the lens creates multiple different sharp focal points with distinct and different focal lengths (e.g., near, intermediate and/or distance vision), rather than blurring the focus (caustic) as in a purely refractive multifocal lens. And by appropriate selection and control of the diffractive and refractive optical elements of the lens, a range of lenses can be manufactured and prescribed for various vision correction applications, such as for example the correction of presbyopia or myopia. The refractive optical power of the contact lens according to example embodiments will be on the order of −12D to +8D and will correct for spherical ameptropia. The refractive power of the contact lens may also include cylindrical power, for example between −0.50D to −2.75D to correct for astigmatism. The optical power (Add power) of the Diffractive component of the contact lens according to example embodiments will be on the order of about 2.5 D for near vision correction and about 1.6 D for intermediate vision correction.

In another example application or method of use, hybrid diffractive-refractive contact lenses according to example embodiments of the invention may be used in connection with treatment regimens seeking to control myopia progression in children. Progressive myopia, which is generally considered to be caused by gradually increasing eye length rather than lens power, can be a serious condition that leads to increasing visual impairment despite the use of successively stronger corrective lenses. Progressive myopia in childhood has also been linked to retinal detachment later in life. Some countries in Asia have reported that more than 80% of youths aged 17 years suffer from myopia and that many are likely to have or develop the progressive condition. It is generally agreed that normal eye development—called emmetropization—is regulated by a feedback mechanism that controls eye length to allow good central focus by accommodation at both distance and at near—called emmetropia—during animal growth. It is therefore assumed that, in progressive myopia, this feedback mechanism goes awry and causes the eye to continue to lengthen excessively even though good corrective lenses are used. Many conflicting theories have been advanced about the nature of the feedback mechanism and, thus, many different treatments for progressive myopia have been proposed.

Known contact lens technology for controlling myopia progression through optical intervention are based on refractive technology to create zones of plus dioptric power. However, each zone can only be for distance vision, near vision, or a progressive (or sharp) transition between the intended powers. Therefore, the performance is limited, and vision will be compromised for designs with sharp and gradual transition from zone to zone. Sharp transitions between distance and near optical zone (e.g., 0.0 D to 2.5 D) will result in visual disturbances (dysphotopsias). Designs with smooth transitions will result in blur and the risk of over-minusing the subjects (i.e., prescribing a contact lens with more minus dioptric power then required). Likewise, degraded image performance can impact compliance with the optical intervention treatment.

Example embodiments of the invention utilize discrete diffractive multifocality over all or select area(s) of the optical zone to reduce accommodative demand for intermediate and near work, while maintaining high quality distance vision. The invention may be combined with aberration control across the optical zone and may include peripheral myopic plus dioptric power utilizing a different zonal combination of diffractive or refractive technology. The diffractive effect of contact lenses as disclosed herein splits light into multiple diffraction orders or channels of energy in a controlled manner. Therefore, sharp acuity can be achieved for multiple vergences (distance, intermediate, near) from a single diffractive zone. The energy distribution among foci, and across the zone (apodization), can be adjusted for vision and efficacy requirements. Peripheral refractive plus dioptric power, to bring off-axis rays (e.g., 20° field angle) to focus in front of the peripheral retina, are believed by some to impact axial elongation of the retina. Therefore, embodiments with peripheral (between 5 mm to 8 mm diametric optical zone) plus (e.g., +2.5 D compared to label power) are envisioned. The refractive optical power of the contact lens will be between −10D to 0D and will correct for spherical ametropia. The refractive power of the contact lens may also include cylindrical power, for example between about −0.50 to −2.75D to correct for astigmatism. The diffractive optical power (Add power) component of the contact lens according to example embodiments will be between +1 to +8D (typically about +2.5D) for the correction of myopia over a central 2-4 mm optical zone diameter. By focusing light energy at a focal point in front of the retina, for example in the peripheral visual field, the eye may tend to grow towards that focal point to counter the progression of myopia in children. Utilizing a combination of peripheral plus and diffractive optical power, the contact lens can be adjusted to control spherical aberration across the peripheral areas of the lens (e.g., peripheral plus, central plus). This combination of refractive (peripheral plus) and diffractive power can form an image in front of the retina peripherally while maintaining a focused image at the central retina.

The diffractive or hybrid design embodiments of contact lenses according to example embodiments of the invention include:
1. Full diffractive spanning the entire optical zone.
2. Central diffractive (D) and concentric peripheral refractive (R) and plurality embodiments (e.g., D; D,R; D,R,D; D,R,D,R . . . ).
3. Central refractive (R) and concentric peripheral diffractive (D) and plurality embodiments (e.g., R,D; R,D,R; R,D,R,D, . . . ).
   As shown in FIGS. 8A-8I, in example embodiments, the widths of the concentric zones may or may not be equal; the areas of the concentric zones may or may not be equal. The bifocal zone(s) distance/near energy balance may range from 85%/15% to 20%/80% (preferably 65%/35%), with add powers between 2 and 6 D (preferably 2.5 to 3.5D). The diffractive zones may utilize a pupil-independent design or may be apodized. The trifocal zone(s) design distance/intermediate/near energy balance may range from 80%/10%/10% to 30%/30%/30% (preferably 60%/20%/20%), with near add powers between 2 and 6 D (preferably 2.5 to 3.5D) and intermediate add power between 0.75 D to 1.75 D (preferably 1.00 D to 1.75 D). The diffractive zones may utilize a pupil-independent design or may be apodized. Both the bifocal and trifocal designs may also be apodized to modify the near and intermediate energy, for example to improve the distance image quality for larger pupil diameters.

Broadly categorized, example embodiments of the invention include:
1. Anterior or posterior surface diffractive structure.
   a. Preferably a sinusoidal diffractive or rounded diffractive structure.
   b. With or without a conforming surface coating.
   c. With a surface coating with an index of refraction difference and appropriately designed step heights that is thin (i.e., on the order of 10 μm) and maintains a smooth surface topography (semi-embedded).
2. A base curve surface diffractive with or without a coating that is designed to be centrally vaulted off the cornea. The gap may be filled with a thick tear film layer or a thick, low modulus coating.
3. A soft or rigid embedded optical element with a refractive index difference between ΔRI 0.03 and 0.3 (preferably 0.1). The diffractive structure may include kinoforms, trifocal forms, achromatizing diffractive design and the like.
4. An opaque or intensity apodizing iris pattern printed outside the central optical zone for diameters greater than 5 mm (preferably greater than 6 mm) to reduce stray light and halo effects due to the diffractive optical element when subtended by large pupils and off-axis rays.

While the invention has been described with reference to example embodiments, it will be understood by those skilled in the art that a variety of modifications, additions and deletions are within the scope of the invention, as defined by the following claims.

What is claimed is:

1. A hybrid diffractive and refractive contact lens for treatment of myopia comprising:
a first lens portion comprising a first lens material having a first index of refraction, the first lens portion comprising at least one diffractive optical element; and
a second lens portion comprising a second lens material having a second index of refraction different from the first index of refraction;
wherein the contact lens provides a refractive optical power of between −10D to 0D in a central optical zone, and a diffractive optical Add power of between +1D to +8D in a peripheral optical zone surrounding the central optical zone.

2. The contact lens of claim 1, wherein the contact lens further provides a cylindrical power of between −0.50D to −2.75D.

3. The contact lens of claim 1, wherein the at least one diffractive optical element of the first lens portion is at least partially embedded within the second lens portion.

4. The contact lens of claim 1, wherein the first lens portion is embedded within the second lens portion.

5. The contact lens of claim 1, wherein a difference in refractive index (ΔRI) between the first refractive index and the second refractive index is at least about 0.08.

6. The contact lens of claim 1, wherein a difference in refractive index (ΔRI) between the first refractive index and the second refractive index is at least about 0.10.

7. The contact lens of claim 1, wherein a difference in refractive index (ΔRI) between the first refractive index and the second refractive index is at least about 3% of the average of the first and second refractive indices.

8. The contact lens of claim 1, wherein a difference in refractive index (ΔRI) between the first refractive index and the second refractive index is at least about 5% of the average of the first and second refractive indices.

9. The contact lens of claim 1, wherein at least one of the first and second lens materials comprise a soft contact lens material selected from silicone hydrogel, hydrogel, silicone elastomer, and combinations thereof.

10. The contact lens of claim 1, wherein the first lens material is selected from verofilcon A, lotrafilcon B, delefilcon A, serafilcon A, lehfilcon A, nelfilcon A, and combinations thereof.

11. The contact lens of claim 1, wherein the second lens material is selected from silicone elastomer, Acrylate PMMA, Fluorosilicone elastomer, and combinations thereof.

12. The contact lens of claim 1, wherein the at least one diffractive optical element comprises a series of peaks and valleys arranged in an annular pattern around a central optical zone.

13. The contact lens of claim 12, wherein the series of peaks and valleys comprise sinusoidal or rounded diffractive structures.

14. The contact lens of claim 1, wherein the diffractive optical Add power of the peripheral zone is about +2.5D.

15. A multifocal diffractive-refractive contact lens for controlling myopia progression, the lens comprising:
a first lens portion comprising a first lens material having a first index of refraction, the first lens portion comprising at least one diffractive optical element;
a second lens portion comprising a second lens material having a second index of refraction different from the first index of refraction;
a central optical zone providing a refractive optical power; and
a peripheral optical zone surrounding the central optical zone, wherein the at least one diffractive optical element provides a diffractive Add power in the peripheral optical zone of between +1D to +8D.

16. The contact lens of claim 15, wherein the refractive optical power is between −10D to 0D.

17. The contact lens of claim 15, wherein the diffractive Add power is about +2.5D.

18. The contact lens of claim 15, wherein the contact lens further provides a cylindrical power of between −0.50D to −2.75D.

19. The contact lens of claim 15, wherein the at least one diffractive optical element of the first lens portion is at least partially embedded within the second lens portion.

20. The contact lens of claim 15, wherein the first lens portion is embedded within the second lens portion.

21. The contact lens of claim 15, wherein a difference in refractive index (ΔRI) between the first refractive index and the second refractive index is at least about 0.08.

22. The contact lens of claim 15, wherein a difference in refractive index (ΔRI) between the first refractive index and the second refractive index is at least about 0.10.

23. The contact lens of claim 15, wherein a difference in refractive index (ΔRI) between the first refractive index and the second refractive index is at least about 3% of the average of the first and second refractive indices.

24. The contact lens of claim 15, wherein a difference in refractive index (ΔRI) between the first refractive index and the second refractive index is at least about 5% of the average of the first and second refractive indices.

25. The contact lens of claim 15, wherein at least one of the first and second lens materials comprise a soft contact lens material selected from silicone hydrogel, hydrogel, silicone elastomer, and combinations thereof.

26. The contact lens of claim 15, wherein the first lens material is selected from verofilcon A, lotrafilcon B, delefilcon A, serafilcon A, lehfilcon A, nelfilcon A, and combinations thereof.

27. The contact lens of claim 15, wherein the second lens material is selected from silicone elastomer, Acrylate PMMA, Fluorosilicone elastomer, and combinations thereof.

28. The contact lens of claim 15, wherein the at least one diffractive optical element comprises a series of peaks and valleys arranged in an annular pattern around a central optical zone.

29. The contact lens of claim 28, wherein the series of peaks and valleys comprise sinusoidal or rounded diffractive structures.

30. A method of treatment of myopia comprising
providing a hybrid diffractive and refractive contact lens to a user, the contact lens comprising a first lens portion comprising a first lens material having a first index of refraction and comprising at least one diffractive optical element, and a second lens portion comprising a second lens material having a second index of refraction different from the first index of refraction;
wherein the contact lens provides an optical correction prescribed to treat a myopic optical condition of the user, the optical correction comprising a refractive optical power of between −10D to 0D in a central optical zone, and a diffractive optical Add power of between +1D to +8D in a peripheral optical zone surrounding the central optical zone; and
wherein the difference in refractive index (ΔRI) between the first refractive index and the second refractive index is at least 0.03.
